(19) United States
(12) Patent Application Publication
(10) Pub. No.: US 2020/0057429 A1
(43) Pub. Date: Feb. 20, 2020

(54) ELECTRONIC MANUAL DISPLAY METHOD AND ELECTRONIC MANUAL CONTROL DEVICE

(71) Applicant: HONDA MOTOR CO., LTD., Minato-ku, Tokyo (JP)

(72) Inventors: Masataka Takao, Minato-ku, Tokyo (JP); Ohki Ito, Minato-ku, Tokyo (JP)

(21) Appl. No.: 16/610,930

(22) PCT Filed: May 11, 2017
(86) PCT No.: PCT/JP2017/017889

§ 371 Date: Nov. 5, 2019

(51) Int. Cl. G05B 19/418; G06F 16/28

(52) U.S. Cl. CPC G05B 19/4183; G06F 16/287; G06Q 30/01; G05B 2219/32128; G05B 2219/31046

(57) ABSTRACT

Provided are an electronic manual display method and an electronic manual control device that make an entire work process easy to grasp, thus allowing for important points of the entire work process to be easily grasped and for important information to be easily grasped. In an electronic manual display method and an electronic manual control device, a disassembled perspective view: indicates a disassembled state where a plurality of individual components constituting an entire component unit are aligned in the same visual field direction together with common auxiliary lines indicating the connection in mutual attachment relationships of the individual components; and indicates link displays in accordance with the arrangement of the individual components. When any one of the link displays is selected, the control device causes a monitor to display a work guide display of an individual component corresponding to the selected link display.

### TECHNICAL FIELD

The present invention relates to an electronic manual display method and an electronic manual control device for displaying manual data explaining work of an individual component configuring a completed product or a component module for the completed product.

### BACKGROUND ART

When engaging in work (inspection, adjustment, learning, installation, removal, and so on) of an individual component for a completed product such as a vehicle or a component module for the completed product, an electronic manual such as a service manual is utilized (Japanese Laid-Open Patent Publication No. 2002-236690 (hereafter, called “JP2002-236690A”).

In JP2002-236690A, a problem to be solved is providing a system that manages by integrating scattered diagnostic/maintenance information, and quickly searches for that integrated information as required ([0006], abstract).

In order to solve the problem, in JP2002-236690A (abstract, FIGS. 2 and 4), components of an automobile are classified into a large category, a medium category, and a small category to construct a hierarchical search structure. Links are provided between respective items included in a service manual database, a troubleshooting database, and a parts database, and related items of the large category, the medium category, and the small category or even lower order items.

In the large category, components of the automobile are classified into large components such as an engine, a transmission, and so on ([0007], FIGS. 2 and 4). In the medium category, the large category is classified into the next level of components (an engine assembly, an engine case cover, an engine cylinder, and so on). In the small category, classification is made into items related to maintenance of the automobile, such as inspection, adjustment, analysis, and so on (FIGS. 5-9, and 11).

### SUMMARY OF INVENTION

As described above, in JP2002-236690A, search is performed using the hierarchical search structure where classification has been made into the large category, the medium category, and the small category (abstract, FIGS. 2 and 4). Then, a specific maintenance item is confirmed by the small category (FIGS. 4-9, and 11).

When maintenance content of an individual component targeted for maintenance (a target component) is confirmed by a user (a worker, and so on), there is sometimes a need for information of an individual component whose removal, and so on, is required to reach the target component (a related component). In such a case, in JP2002-236690A, even for simple work related to the target component, there arises a need for a relationship of the target component and the related component to be checked by the user himself or herself whereupon a plurality of items of the small category are each found and confirmed, in order for entire work including work of the related component to be understood. Such work is extremely time-consuming and is difficult to understand since information that should be noted is scattered.

A wide variety of demands are made of electronic manuals in the market. For example, in a repair site of a vehicle, work speed to prevent a customer from being kept waiting is an extremely important item in everyday maintenance work. It is therefore extremely important to configure such that a main point of individual maintenance work of a vehicle that has been brought in, can be efficiently understood in a short time.

The present invention has been made in view of the above-described circumstances, and has an object of providing an electronic manual display method and an electronic manual control device capable of achieving that “entire work is easy to understand”, “a main point of entire work can be easily understood”, and “important information can be easily understood”.

An electronic manual display method according to the present invention is a method by which a control device acquires, from a storage device, manual data explaining work of a plurality of individual components configuring a completed product or a component module for the completed product, and displays the manual data on a monitor,

wherein the manual data at least includes:

disassembled perspective view data relating to a disassembled perspective view of an entire component unit that includes some of the plurality of individual components and configures the completed product or the component module;

work guide data relating to a work guide display explaining work of the individual component; and

work guide link data relating to a link display associating each of the individual components in the disassembled perspective view with the work guide display,

wherein the disassembled perspective view of the entire component unit displays the plurality of individual components in a disassembled state where the plurality of individual components are aligned in a same visual field direction, along with a common auxiliary line indicating linkage of mutual installation relationships of the plurality of individual components, and

wherein the control device

displays the link display correspondingly to an arrangement of the individual component, in the disassembled perspective view of the entire component unit, and

when any one of the link displays is selected via an operation input device configured to receive operation input from a user, displays the work guide display of the individual component corresponding to the selected link display on the monitor.

According to the present invention, the disassembled perspective view in which the plurality of individual components have been displayed in an aligned disassembled state in the same visual field direction along with the common auxiliary line indicating linkage of mutual installation relationships of the plurality of individual components, is displayed for the entire component unit. It therefore becomes possible for the user to easily understand, just by one glance, where the component that is a target of the work of the user himself or herself (the target component) is positioned in the disassembled perspective view of the entire component unit, and an entire order of removal to get to the target component or installation from the target component onward.

Moreover, when the link display corresponding to the individual component is selected by the user in the disassembled perspective view, the work guide display of the selected individual component is displayed. When the target component has been selected as the individual component selected by the user, the user can easily reach the work guide display of the target component. Furthermore, when the link display corresponding to the component related to installation or removal of the target component (the related component) is selected by the user, the user can select and view solely the work guide display of the related component that the user is interested in. It therefore becomes possible for the user to quickly select and understand required work and important information that should be noted regarding that work.

The above makes it possible to achieve that “entire work is easy to understand”, “a main point of entire work can be easily understood”, and “important information can be easily understood”.

The control device may display, with substantially a same reduction scale in the disassembled perspective view, all or some of the plurality of individual components configuring the component unit. This makes it easy for the user to imagine actual entire work just by looking at the disassembled perspective view. Note that “substantially the same reduction scale” herein includes, in addition to the same reduction scale, a reduction scale of a degree at which the user does not visually feel a difference in reduction scale (for example, a difference in the reduction scale between a specific individual component and another individual component being in a range of 0-10%).

A component that is installed or removed in a non-disassembled state may be displayed in the disassembled perspective view as the individual component unchanged in the non-disassembled state. As a result, the user does not need to take into account unrequired disassembly work and so on, and can confirm installation or removal of the individual component in a display state based on an actual work state. Moreover, compared to the case of display in a disassembled state, a required display region becomes smaller and therefore an entire display becomes easier to see in the case of display in the non-disassembled state.

The manual data may include the disassembled perspective view data for a plurality of the component units. In addition, the control device may display, all together, thumbnails of a plurality of the disassembled perspective views corresponding to the plurality of component units. Furthermore, when any one of the disassembled perspective views displayed as the thumbnails is selected via the operation input device, the control device may display the selected disassembled perspective view in an enlarged form on the monitor together with the link display. This makes it possible for the user to utilize a thumbnail display to visually or intuitively retrieve which component unit includes the component that is a target of the work of the user himself or herself (the target component).

The control device may display the plurality of individual components in the disassembled perspective view without displaying names thereof. Moreover, the control device may include, in the disassembled perspective view, the link display that has been symbolized, and may display an explanation of the symbolized link display in a blank space. As a result, although there is a limitation on the display region of the monitor, lowering of visibility due to a large number of detailed names being displayed is avoided, so that the individual components are each made conspicuous, thereby enabling visibility of the user to be improved.

In the present embodiment, the individual components in the disassembled perspective view may each include a screw. The manual data may include data of a number of screws that are required for each fastening region of the screw. The control device may display one screw along with the number of screws, for each fastening region of the screw, in the disassembled perspective view.

As a result, in the disassembled perspective view, one screw is displayed for each fastening region of the screw, hence, although there is a limitation on the display region of the monitor, the individual components are each more largely displayed, thereby enabling visibility of the user to be improved. In addition, since the number of screws is displayed, the user can recognize the required number of screws.

An electronic manual display system according to the present invention is a system that acquires, from a database, manual data required in work of a plurality of individual components configuring a completed product or a component module for the completed product, and displays the manual data on a monitor,

wherein the manual data at least includes:

disassembled perspective view data relating to a disassembled perspective view of an entire component unit that includes some of the plurality of individual components and configures the completed product or the component module;

work guide data relating to a work guide display explaining work of the individual component; and

work guide link data relating to a link display associating each of the individual components in the disassembled perspective view with the work guide display,

wherein the disassembled perspective view of the entire component unit displays the plurality of individual components in a disassembled state where the plurality of individual components are aligned in a same visual field direction, along with a common auxiliary line indicating linkage of mutual installation relationships of the plurality of individual components, and

wherein the electronic manual control device

displays the link display correspondingly to an arrangement of the individual component, in the disassembled perspective view of the entire component unit, and

when any one of the link displays is selected via an operation input device configured to receive operation input from a user, displays the work guide display of the individual component corresponding to the selected link display on the monitor.

According to the present invention, entire work is easy to understand, a main point of entire work can be easily understood, and important information can be easily understood.

The manual data may include: classification data relating to a classification display indicating a high order classification including a plurality of the component units; and hierarchy data relating to a display hierarchy. Moreover, the electronic manual control device may display the classification display on a screen of higher order hierarchy than the disassembled perspective view, based on the hierarchy data.

This enables a hierarchical structure to be partially adopted for display. Hence, it enables labor involved in construction or improvement, version upgrading, or data updating of the system, to be simplified. In addition, the classification display indicating classification of a work item is displayed on a screen of higher order hierarchy than the disassembled perspective view, thereby making it easy for the user to reach the disassembled perspective view using the classification display as a guide.

### BRIEF DESCRIPTION OF DRAWINGS

FIG. 1 is a view showing a schematic configuration of an electronic manual display system including an arithmetic operation section as an electronic manual control device according to an embodiment of the present invention;

FIG. 2 is a flowchart showing one example of an overall flow when actually using an electronic manual in the embodiment;

FIG. 3 is a view explaining change of screens in the electronic manual of the embodiment;

FIG. 4 is a view showing one example of a high order category selection screen of the embodiment;

FIG. 5 is a view showing one example of a thumbnail screen of the embodiment;

FIG. 6 is a view showing a first example of an enlarged display screen of the embodiment;

FIG. 7 is a view showing a second example of the enlarged display screen of the embodiment;

FIG. 8 is a view showing a third example of the enlarged display screen of the embodiment;

FIG. 9 is a view showing a first example of a work guide screen of the embodiment;

FIG. 10 is a view showing a second example of the work guide screen of the embodiment;

FIG. 11 is a view showing one example of a detailed work screen of the embodiment;

FIG. 12 is a view explaining one example of change of screens in an electronic manual of a modified example;

FIG. 13 is a view showing a first example of a screen in the modified example;

FIG. 14 is a view showing a second example of a screen in the modified example; and

FIG. 15 is a view showing a third example of a screen in the modified example.

### DESCRIPTION OF EMBODIMENTS

### A. Embodiment

### A-1. Configuration

### (A-1-1. Overall Configuration)

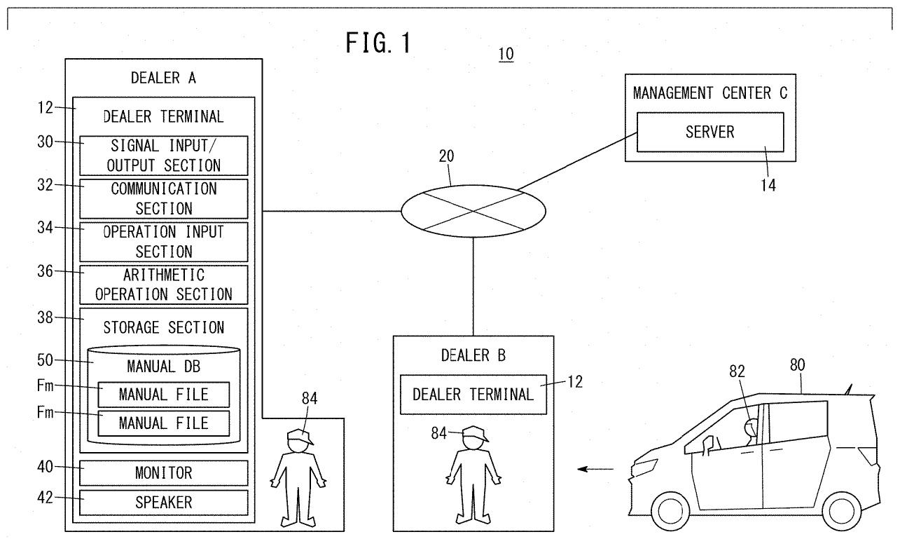

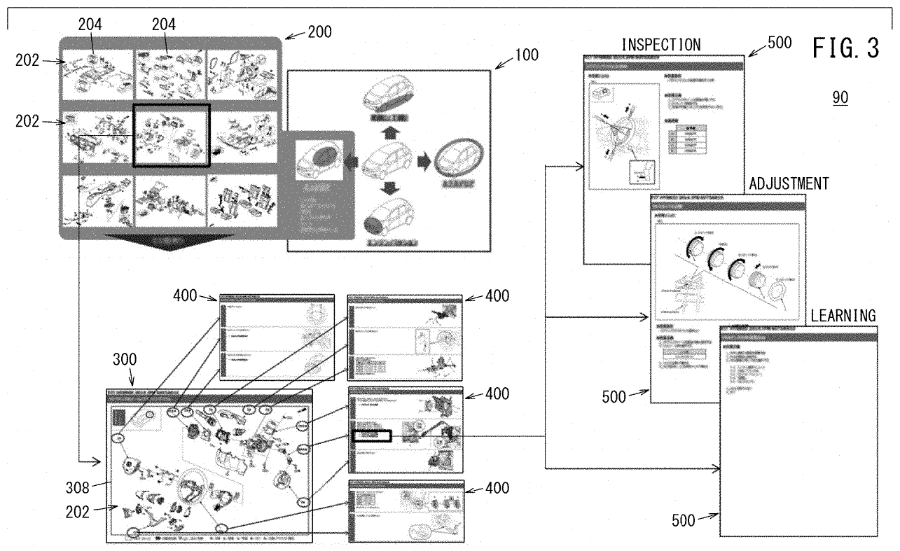

FIG. 1 is a view showing a schematic configuration of an electronic manual display system 10 (hereafter, also referred to as “system 10” or “display system 10”) including an arithmetic operation section 36 as an electronic manual control device according to an embodiment of the present invention. The system 10 is a system for displaying an electronic manual 90 (FIG. 3) used when performing maintenance and diagnostics of a vehicle 80.

The system 10 includes a plurality of dealer terminals 12 (hereafter also called “terminals 12”) and a server 14. The terminals 12 are disposed in a plurality of vehicle dealers A, B (hereafter, also called “dealers A, B”) as service bases. The server 14 is disposed in a management center C. In the present embodiment, each of the terminals 12 and the server 14 are capable of communicating with each other via a communication network 20.

### (A-1-2. Dealer Terminal 12)

A customer 82 brings his or her own vehicle 80 into the dealers A, B with the purpose of maintenance or diagnostics. The dealer terminal 12 is employed when a worker 84 (technician) or the like in the dealers A, B refers to the electronic manual 90 for performing maintenance or diagnostics of the vehicle 80 (completed product).

As shown in FIG. 1, the terminal 12 includes a signal input/output section 30, a communication section 32, an operation input section 34, the arithmetic operation section 36, a storage section 38, a monitor 40, and a speaker 42. The signal input/output section 30 performs input/output of a signal between the terminal 12 and an external apparatus. The communication section 32 communicates with the server 14 via the communication network 20. The communication section 32 may be regarded as part of the signal input/output section 30. The operation input section 34 (operation input device) is an apparatus by which a user such as the worker 84 performs input/output, and includes, for example, a keyboard and a mouse.

The arithmetic operation section 36 executes a various kinds of processing by controlling each of the sections of the terminal 12. The arithmetic operation section 36 of the present embodiment reads data Dm (hereafter, also called “manual data Dm”) of the electronic manual 90 (FIG. 3) from the storage section 38 based on input from the operation input section 34, and displays the data Dm on the monitor 40. Moreover, the arithmetic operation section 36 acquires the latest manual data Dm from the server 14 via the communication section 32 and the network 20. In the present embodiment, the manual data Dm is used in a format of a manual file Fm.

The storage section 38 (storage device) stores various kinds of programs such as a control program employed by the arithmetic operation section 36, or data. Data referred to herein includes a plurality of manual data Dm (manual files Fm) corresponding to a plurality of vehicle models. The storage section 38 comprises a manual database 50 (hereafter, called “manual DB 50”) in which the plurality of manual data Dm (manual files Fm) are accumulated.

Each of the manual data Dm includes disassembled perspective view data Depv, work guide link data Dogl, screw work data Dscw, work guide data Dog, and detailed work link data Ddol.

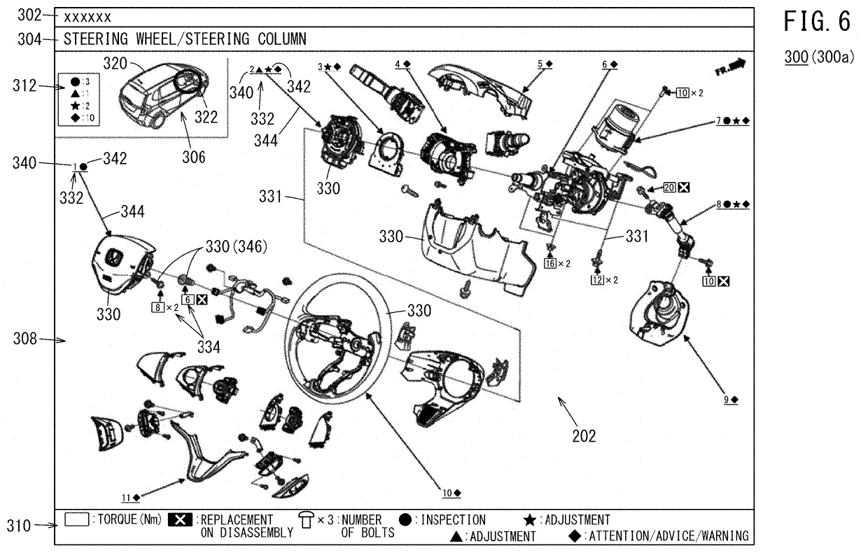

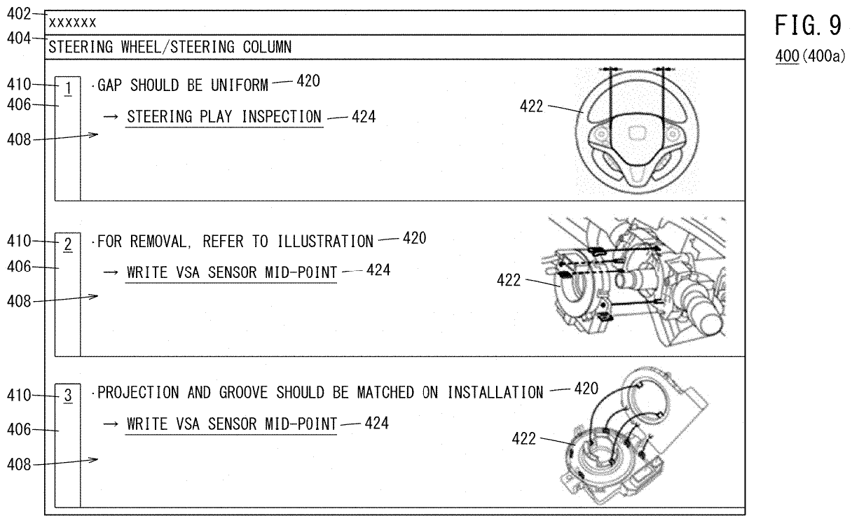

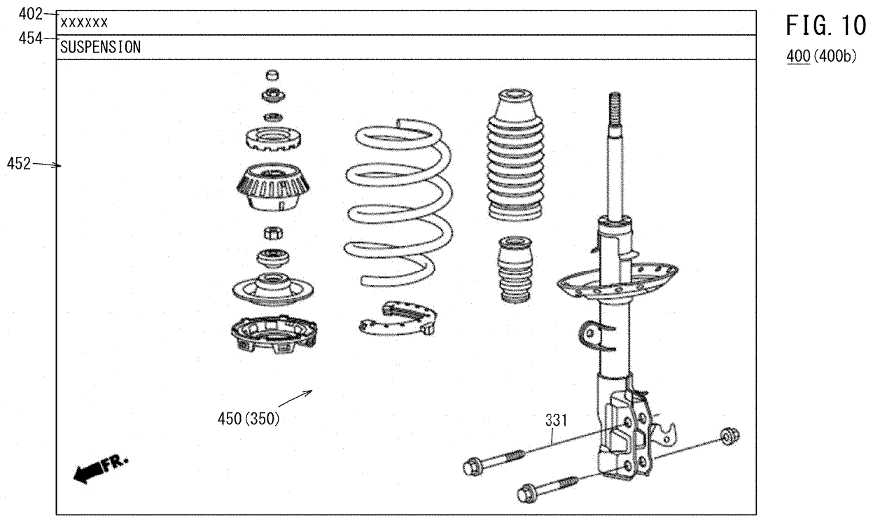

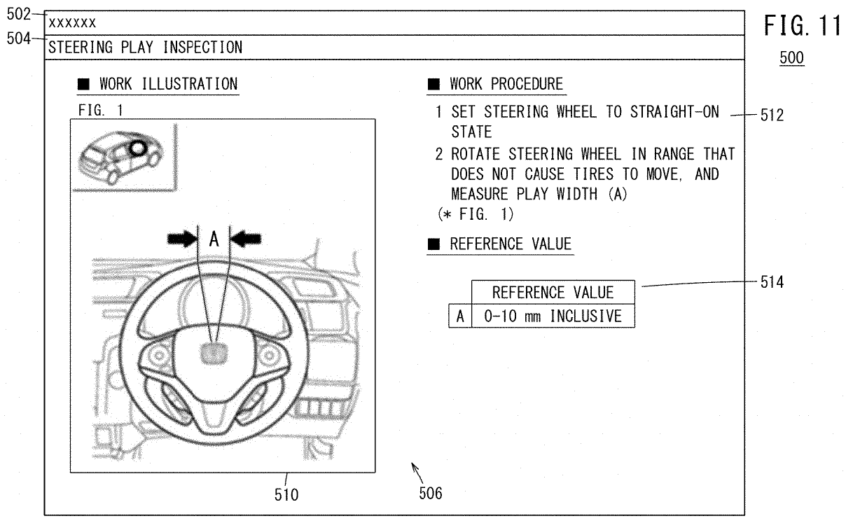

The disassembled perspective view data Depv is data relating to disassembled perspective views 204, 308 (FIGS. 3, and 5-8) that will be mentioned later. The work guide link data Dogl is data that links an individual component 330 (FIGS. 6-8) in the disassembled perspective view 308 and a work guide screen 400 (FIGS. 9 and 10). The screw work data Dscw is data relating to work (required number and target torque) of a screw 346 (FIG. 6) as the individual component 330. The work guide data Dog is data relating to the work guide screen 400. The detailed work link data Ddol is data that links the work guide screen 400 and a detailed work screen 500 (FIG. 11).

The monitor 40 displays the electronic manual 90 (FIG. 3), and so on, based on an instruction from the arithmetic operation section 36. The speaker 42 outputs a sound accompanying display of the electronic manual 90, based on an instruction from the arithmetic operation section 36.

As a hardware configuration of the terminal 12, there may be adopted, for example, a desktop type or notebook type personal computer. Alternatively, a commercially available tablet type computer or smartphone may be employed. Note that although FIG. 1 shows an internal configuration only of the terminal 12 of dealer A, the terminal 12 of dealer B also has a similar configuration.

### (A-1-3. Server 14)

The server 14 manages the entire system 10, and provides the terminal 12 of each of the dealers A, B with the latest manual file Fm. The server 14 comprises a signal input/output section, a communication section, an operation input section, an arithmetic operation section, a storage section, a monitor, and a speaker (none of which is illustrated), similarly to the terminal 12. The storage section of the server 14 includes a manual database in which the latest manual files Fm are accumulated.

### A-2. Use of Electronic Manual 90

### (A-2-1. Advance Preparation)

As advance preparation for the worker 84 to use the electronic manual 90, the worker 84 or somebody of the dealers A, B updates the manual data Dm in the manual DB 50 of the terminal 12 to the latest manual data Dm. During updating of the manual file Fm, connection is made from the terminal 12 to the server 14, and presence/absence of an updated or newly added manual file Fm is confirmed. If there is an updated or newly added manual file Fm, this manual file Fm is downloaded to the terminal 12 from the server 14.

Note that in the case where the manual file Fm is acquired from the server 14 during use of the electronic manual 90, without the manual DB 50 being stored in the storage section 38 of the terminal 12, the above-described advance preparation is unnecessary.

### (A-2-2. Overall Flow During Actual Use)

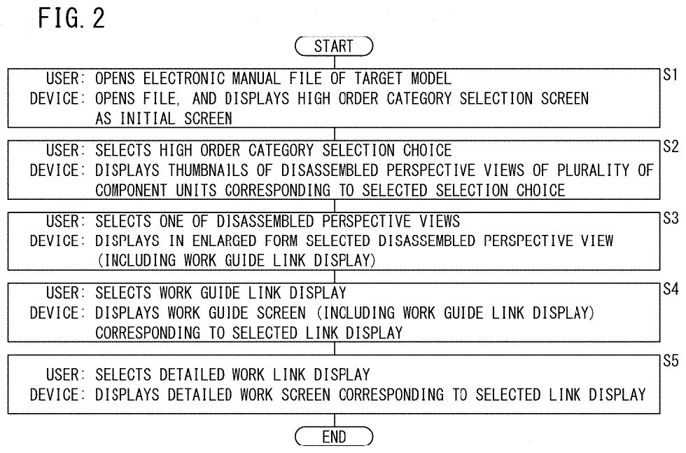

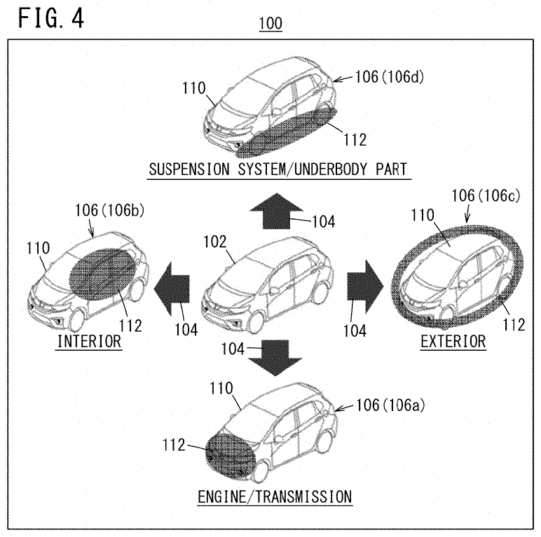

FIG. 2 is a flowchart showing one example of an overall flow when actually using the electronic manual 90 in the present embodiment. FIG. 3 is a view explaining change of screens in the electronic manual 90 of the present embodiment. FIGS. 4-11 are views showing first through eighth examples of a screen in the present embodiment.

In step S1 of FIG. 2, the worker 84 as the user operates the operation input section 34 of the terminal 12 to open an electronic manual file Fm (hereafter, also called “manual file Fm” or “file Fm”) of the vehicle model (target vehicle model) to which the vehicle 80 corresponds. In other words, the arithmetic operation section 36 opens the file Fm corresponding to the target vehicle model, based on input to the operation input section 34. The file Fm may be selected by inputting a vehicle model name in a search field of a screen of the monitor 40.

A high order category selection screen 100 (FIGS. 3 and 4) is displayed on the monitor 40 by the arithmetic operation section 36, as an initial screen immediately after the electronic manual file Fm has been opened. The high order category selection screen 100 (hereafter, also called “selection screen 100”) includes a plurality of high order category selection choices 106a-106d. Hereafter, the high order category selection choices 106a-106d will also be called “selection choices 106a-106d”, and be collectively referred to as “high order category selection choices 106” or “selection choices 106”. Although in FIGS. 3 and 4, the selection choices 106a-106d are configured as illustrations, they may be configured as just characters.

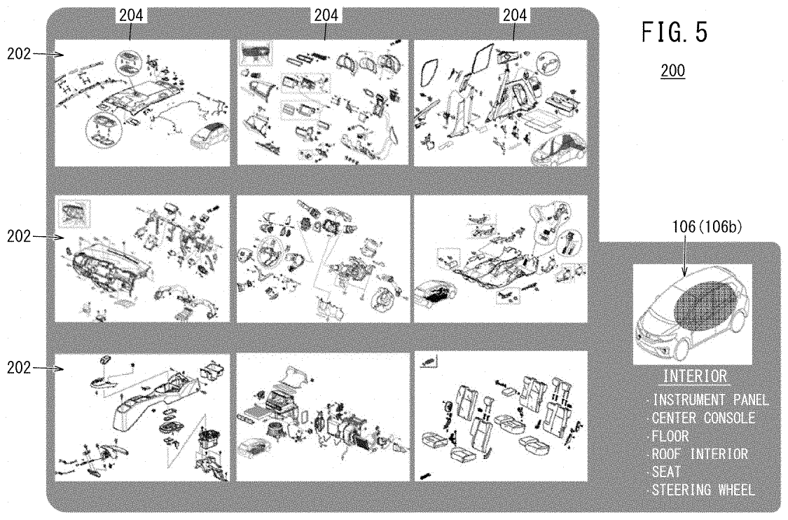

In step S2, the worker 84 selects the high order category selection choice 106 where the individual component 330 that the worker 84 is interested in is present, from the high order category selection choices 106 displayed on the high order category selection screen 100. Correspondingly, the arithmetic operation section 36 highlights the selection choice 106 selected based on input to the operation input section 34. Displaying by a more conspicuous color, for example, may be performed as the highlighting here. In addition, the arithmetic operation section 36 displays a thumbnail screen 200 that includes the disassembled perspective views 204 of a plurality of component units 202 corresponding to the selected selection choice 106 (FIGS. 3 and 5).

Note that the individual component 330 that the worker 84 is interested in may be a component that is a target of the work of the worker 84 himself or herself (hereafter, also called “target component 330tar”). Alternatively, the individual component 330 that the worker 84 is interested in may be a component related to installation or removal of the target component 330tar (hereafter, also called “related component 330ass”). Description will be made here assuming that the individual component 330 that the worker 84 is interested in is the target component 330tar.

In step S3, the worker 84 selects the disassembled perspective view 204 where the target component 330tar is present, from the displayed plurality of disassembled perspective views 204. Correspondingly, the arithmetic operation section 36 displays an enlarged display screen 300 that includes the disassembled perspective view 308 that is an enlargement of the disassembled perspective view 204 selected based on input to the operation input section 34 (FIGS. 3, and 6-8). By looking at the enlarged disassembled perspective view 308, the worker 84 can recognize a position, and so on, of the target component 330tar. Moreover, the worker 84 can understand an order or work process of removal or installation, from an arrangement relationship of the target component 330tar and the related component 330ass. The enlarged disassembled perspective view 308 includes work guide link displays 332 corresponding to a plurality of the individual components 330.

In step S4, the worker 84 selects the work guide link display 332 corresponding to the individual component 330 having an effect related to work of the target component 330tar, from the plurality of individual components 330 in the enlarged disassembled perspective view 308. Correspondingly, the arithmetic operation section 36 displays the work guide screen 400 corresponding to the selected work guide link display 332 (FIGS. 3, 9, and 10).

The work guide screen 400 includes a description (work explanation text 420) and an illustration 422 related to work of the individual component 330. The worker 84 performs work (inspection, adjustment, learning, installation, removal, and so on) of the individual component 330 with reference to the description and illustration 422.

In addition, some of the work guide screens 400 include a link display 424 (hereafter, also called “detailed work link display 424”) relating to details of inspection, adjustment, or learning, or to a disassembled perspective view 452 of a component sub-unit 450 configuring the component unit 202 (FIG. 9). The link display 424 is displayed as a simple explanation (a kind of title) relating to the details of inspection, adjustment, or learning, or to the disassembled perspective view 452 of the component sub-unit 450.

In step S5, the worker 84 selects the detailed work link display 424 that the worker 84 is interested in, from the detailed work link displays 424 included in the work guide screen 400. Correspondingly, the arithmetic operation section 36 displays the detailed work screen 500 corresponding to the selected link display 424 (FIGS. 3 and 11). Note that the detailed work link display 424 similar to that in the work guide screen 400 may be included also in the detailed work screen 500. The link display 424 included in the detailed work screen 500 corresponds to a detailed work screen 500 different from the currently-displayed detailed work screen 500.

### (A-2-3. Description of Each Screen)

Next, each of the screens included in the electronic manual file Fm will be further described. As described above, in the present embodiment, the high order category selection screen 100, the thumbnail screen 200, the enlarged display screen 300, the work guide screen 400, and the detailed work screen 500 are displayed as screens (FIG. 3).

### (A-2-3-1. High Order Category Selection Screen 100)

FIG. 4 is a view showing one example of the high order category selection screen 100 of the present embodiment. The high order category selection screen 100 has displayed therein an illustration 102 of the vehicle 80 (FIG. 1) and arrows 104, in addition to the above-mentioned high order category selection choices 106a-106d. The four selection choices 106a-106d are each disposed, along with the arrow 104, above, below, to the left, or to the right of the illustration 102 of the vehicle 80 which is positioned in a center.

In the example of FIG. 4, the selection choice 106a corresponds to an engine/transmission of the vehicle 80. The selection choice 106b corresponds to an interior of the vehicle 80. The selection choice 106c corresponds to an exterior of the vehicle 80. The selection choice 106d corresponds to a suspension system or underbody part of the vehicle 80. As described above, when any one of the selection choices 106 is selected by the worker 84, the thumbnail screen 200 corresponding to the selected selection choice 106 is displayed (FIG. 3).

Moreover, each of the selection choices 106a-106d includes an illustration 110 of the vehicle 80, and a highlighted region 112. The highlighted region 112 indicates a place corresponding to each of the selection choices 106a-106d. For example, the highlighted region 112 of the selection choice 106a highlights a place corresponding to the engine and transmission of the vehicle 80 (illustration 110).

### (A-2-3-2. Thumbnail Screen 200 of Plurality of Component Units 202)

FIG. 5 is a view showing one example of the thumbnail screen 200 of the present embodiment. As shown in FIG. 5, the thumbnail screen 200 displays thumbnails of the disassembled perspective views 204 of the plurality of component units 202. In addition, the thumbnail screen 200 of the present embodiment also includes the selection choice 106 (in the example of FIG. 5, the selection choice 106b) selected on the high order category selection screen 100. The selection choice 106 need not be included in the thumbnail screen 200.

Note that in the thumbnail screen 200, the later-mentioned work guide link display 332 is displayed extremely small. Alternatively, the work guide link display 332 may not be displayed in the thumbnail screen 200.

### (A-2-3-3. Enlarged Display Screen 300 of Selected Component Unit 202)

### (A-2-3-3-1. Outline)

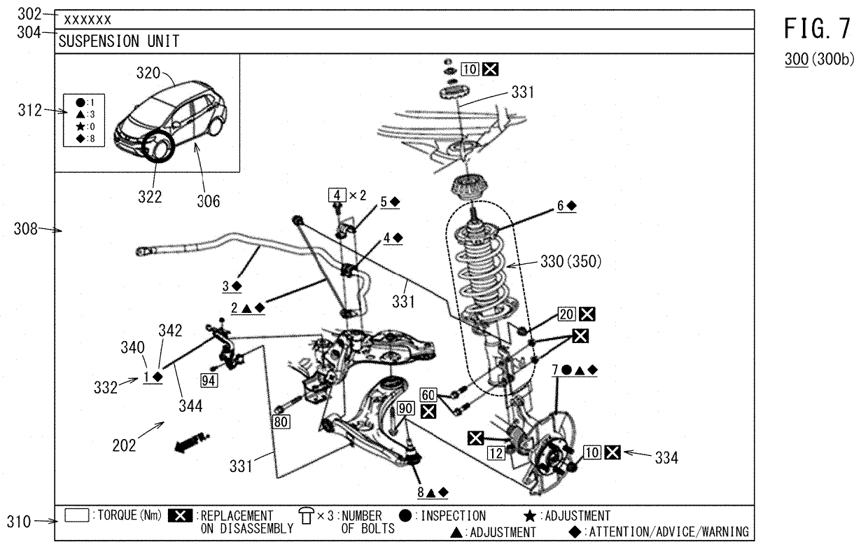

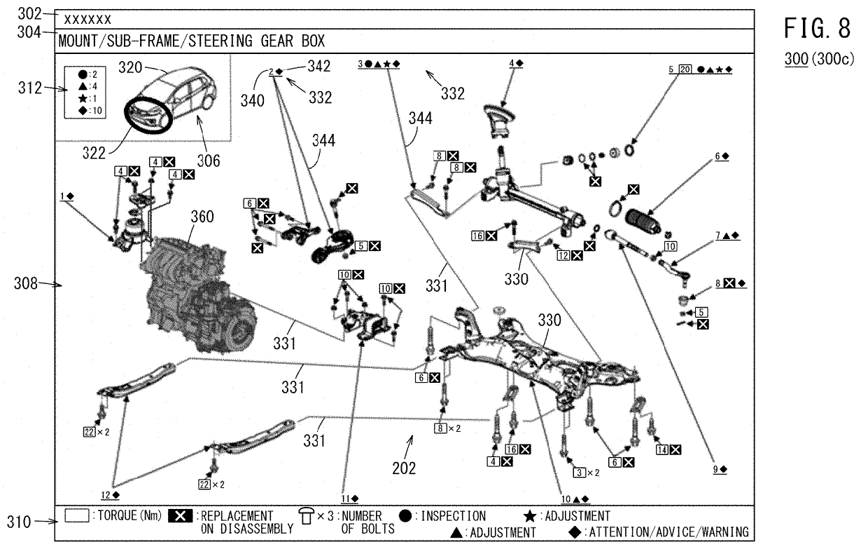

FIGS. 6-8 are views showing first through third examples of the enlarged display screen 300 of the present embodiment. Hereafter, the enlarged display screen 300 of FIG. 6 will also be called enlarged display screen 300a, the enlarged display screen 300 of FIG. 7 will also be called enlarged display screen 300b, and the enlarged display screen 300 of FIG. 8 will also be called enlarged display screen 300c.

As shown in FIGS. 6-8, each of the enlarged display screens 300 includes a model code display field 302, a component unit name display field 304, a position display field 306, the disassembled perspective view 308, a symbol explanation field 310, and a number-of-marks display field 312.

### (A-2-3-3-2. Model Code Display Field 302 and Component Unit Name Display Field 304)

The model code display field 302 displays a model code of the vehicle 80. The component unit name display field 304 displays a name of the component unit 202 selected on the thumbnail screen 200 (hereafter, also called “selected component unit 202sel”). In other words, the disassembled perspective view 308 in the enlarged display screen 300 is a disassembled perspective view that, for the entire component unit 202 described in the component unit name display field 304, displays the component unit 202 in a disassembled state.

### (A-2-3-3-3. Position Display Field 306)

The position display field 306 shows where the targeted component unit 202 on the enlarged display screen 300 is positioned in the vehicle 80. That is, the position display field 306 includes an illustration 320 of the vehicle 80, and a position display 322 indicating the position of the component unit 202.

### (A-2-3-3-4. Disassembled Perspective View 308)

The disassembled perspective view 308 is a perspective view showing each of the individual components 330 configuring the selected component unit 202sel in a state of having been aligned in order of installation in the same visual field direction. Moreover, the individual components 330 to be mutually assembled are each associated by an auxiliary line 331 (a penetrating line or connecting line) indicating mutual installation relationships of the individual components 330. This makes it easy to clearly understand positional relationships of the individual components 330.

The auxiliary line 331 is disposed so as to penetrate a through-hole of each of the individual components 330 to be installed by the screw 346 (FIG. 6), for example. The auxiliary line 331 may be provided correspondingly to a connecting member such as a pin, besides the screw 346. Alternatively, the auxiliary line 331 may also be provided correspondingly to a connecting region configured from a projection such as a boss, and a recess corresponding to this projection.

Furthermore, in the disassembled perspective view 308, all or some of the plurality of individual components 330 are displayed with substantially the same reduction scale. What is referred to here as “substantially the same reduction scale” includes, in addition to the same reduction scale, a reduction scale of a degree at which the worker 84 does not visually feel a difference in reduction scale (for example, a difference in the reduction scale between a specific individual component and another individual component being in a range of 0-10%).

The disassembled perspective view 308 of the present embodiment includes the work guide link display 332 and a screw work display 334, in addition to the perspective view of each of the individual components 330 displayed in a state of having been organized as described above, and the auxiliary line 331. Moreover, it should be noted that in the present embodiment, names and explanations (character display) of the individual components 330 are excluded (that is, are not displayed).

The work guide link display 332 (hereafter, also called “link display 332”) is a link to the work guide screen 400 (FIGS. 3, 9, and 10) relating to work of each of the individual components 330. As described above, when a specific work guide link display 332 is selected, the work guide screen 400 corresponding to the selected link display 332 is displayed (FIG. 3).

In the present embodiment, the work guide link display 332 includes a serial number 340 and a link mark 342. Each of the link displays 332 is associated, by an arrow 344, with a corresponding individual component 330. The serial number 340 is a serial number in each of the enlarged display screens 300, and, in the present embodiment, the serial number 340 is set so as to be “1, 2, 3, . . . ” clockwise along an outer frame of the disassembled perspective view 308. This makes it easy to recognize presence of the link display 332.

The link mark 342 is symbolized for each kind of the work guide screen 400. In the present embodiment, a black circle “●” indicates presence of information about inspection work. A black triangle “▴” indicates presence of information about adjustment work. An asterisk “★” indicates presence of information about learning work. A black square “♦” indicates presence of information relating to attention/advice/warning when engaging in work. Details of the information about inspection, adjustment, learning, and attention/advice/warning will be described in relation to the work guide screen 400 and the detailed work screen 500.

The screw work display 334 shows work of a screw (for example, the screw 346 of FIG. 6). Specifically, a target torque [N] for fastening the screw is displayed surrounded by a square frame. Moreover, a required number of screws is shown along with a multiplication symbol “×”, thereby indicating the required number. Furthermore, a screw requiring replacement at a time of disassembly is shown by a white cross with black background.

In the present embodiment, in the perspective view of each of the individual components 330 included in the disassembled perspective view 308, the component that is installed or removed in a non-disassembled state during installation or removal of another individual component 330 is displayed as the individual component 330 unchanged in the non-disassembled state. For example, as shown in FIG. 7, in the enlarged display screen 300b, a suspension 350 is displayed as the individual component 330 in an assembled state.

Moreover, in the present embodiment, in order to facilitate understanding of a positional relationship of the component unit 202 and the individual components 330 in the vehicle 80, an individual component 330 not included in a component unit 202 may be included in the disassembled perspective view 308. For example, in the enlarged display screen 300c of FIG. 8, a mount, a sub-frame, and a steering gear box are the component unit 202. An engine 360 not included in this component unit 202 (mount, sub-frame, and steering gear box) is included in the disassembled perspective view 308 of FIG. 8, in a state where a display form (for example, a display color or kind of line) has been differentiated from those of other individual components 330.

### (A-2-3-3-5. Symbol Explanation Field 310 and Number-of-Marks Display Field 312)

The symbol explanation field 310 is a field that explains content of the above-mentioned link mark 342 and screw work display 334. The number-of-marks display field 312 displays the number of marks for each kind of the link mark 342.

### (A-2-3-4. Work Guide Screen 400 of Individual Component 330)

FIGS. 9 and 10 are views showing first and second examples of the work guide screen 400 of the present embodiment. The example of FIG. 9 corresponds to the enlarged display screen 300a of FIG. 6, and the example of FIG. 10 corresponds to the enlarged display screen 300b of FIG. 7. Hereafter, the work guide screen 400 of FIG. 9 will also be called work guide screen 400a, and the work guide screen 400 of FIG. 10 will also be called work guide screen 400b. The work guide screen 400a guides inspection work of the individual component 330. The work guide screen 400b includes the disassembled perspective view 452 of the individual component 330 (suspension 350) as the component sub-unit 450 configuring the component unit 202.

In the case where the work guide screen 400 relates to details of inspection, adjustment, or learning of each of the individual components 330, the work guide screen 400 includes a model code display field 402, a component unit name display field 404, a serial number display field 406, and a work explanation field 408, as shown in FIG. 9. Of these, the serial number display field 406 and the work explanation field 408 are provided for each work guide link display 332 of the enlarged display screen 300.

The model code display field 402 and the component unit name display field 404 are similar to the model code display field 302 and the component unit name display field 304 of the enlarged display screen 300.

The serial number display field 406 displays a serial number 410 corresponding to the work guide link display 332 selected on the enlarged display screen 300 (hereafter, also called “selected link display 332sel”). In addition to the serial number display field 406 and work explanation field 408 corresponding to the selected link display 332sel, the serial number display field 406 and work explanation field 408 corresponding to another work guide link display 332 are also included in the present embodiment.

The work explanation field 408 includes the work explanation text 420, the illustration 422, and the detailed work link display 424. The work explanation text 420 explains work of the individual components 330 corresponding to the selected link display 332sel and the other link display 332. The illustration 422 displays, by a simple illustration diagram, work of the individual components 330 corresponding to the selected link display 332sel and the other link display 332.

The detailed work link display 424 is a link to the detailed work screen 500 (FIGS. 3 and 11) that relates to details of information of inspection, adjustment, or learning of each of the individual components 330, or to the disassembled perspective view 452 of the component sub-unit 450 configuring the component unit 202. As described above, when a specific detailed work link display 424 is selected, the detailed work screen 500 corresponding to the selected link display 424 is displayed (FIGS. 3 and 11). The link display 424 is displayed as a simple explanation (a kind of title) relating to the details of inspection, adjustment, or learning, or to the disassembled perspective view 452 of the component sub-unit 450.

In the case where the work guide screen 400 includes the disassembled perspective view 452 of the component sub-unit 450 configuring the component unit 202, the work guide screen 400 includes the model code display field 402 and a component sub-unit name display field 454, in addition to the disassembled perspective view 452, as shown in FIG. 10. Of these, the disassembled perspective view 452 and the component sub-unit name display field 454 are provided for each work guide link display 332 of the enlarged display screen 300.

The disassembled perspective view 452 shows a state where the component sub-unit 450 displayed as an integrated individual component 330 in the enlarged display screen 300 has been disassembled. In the case of the example of FIG. 10, similar displays to those of all or some of the position display field 306, the symbol explanation field 310, and the number-of-marks display field 312 of each of the enlarged display screens 300 of FIGS. 6-8 may be included.

The component sub-unit name display field 454 displays a name of the component sub-unit 450 selected on the enlarged display screen 300 (hereafter, also called “selected component sub-unit 450sel”). In other words, the disassembled perspective view 452 in the work guide screen 400b is a disassembled perspective view of the component sub-unit 450 described in the component sub-unit name display field 454.

### (A-2-3-5. Detailed Work Screen 500 of Individual Component 330)

FIG. 11 is a view showing one example of the detailed work screen 500 of the present embodiment. The example of FIG. 11 corresponds to the work guide screen 400a of FIG. 9.

As shown in FIG. 11, the detailed work screen 500 includes a model code display field 502, a work name display field 504, and a work explanation field 506. The model code display field 502 is similar to the model code display fields 302, 402 of the enlarged display screen 300 and work guide screen 400. The work name display field 504 displays a work name (hereafter, called “work name Nop”) corresponding to the detailed work screen 500. The work name Nop in the present embodiment is the same as content (characters) of the detailed work link display 424 of the work guide screen 400.

The work explanation field 506 of FIG. 11 includes an illustration 510, a work procedure explanation field 512, and a reference value explanation field 514. The illustration 510 shows work of the individual component 330 corresponding to the work name Nop. The work procedure explanation field 512 shows a work procedure of the individual component 330 corresponding to the work name Nop. The reference value explanation field 514 shows a reference value in work of the individual component 330 corresponding to the work name Nop. A work conditions explanation field or a supplementary explanation field, for example, may be provided in addition to these, or instead of some of these. The work conditions explanation field shows conditions for performing work of the individual component 330 corresponding to the work name Nop. The supplementary explanation field shows a supplementary explanation of work of the individual component 330 corresponding to the work name Nop.

### A-3. Advantages of Present Embodiment

As described above, according to the present embodiment, the disassembled perspective view 308, in which the plurality of individual components 330 have been displayed in an aligned disassembled state in the same visual field direction along with the common auxiliary line 331 indicating linkage of mutual installation relationships of the plurality of individual components 330, is displayed for the entire component unit 202 (FIGS. 6-8). It therefore becomes possible for the worker 84 (user) to easily understand, just by one glance, where the individual component 330 that is a target of the work of the worker 84 himself or herself (the target component 330tar) is positioned in the disassembled perspective view 308 of the entire component unit 202, and an entire order of removal to get to the target component 330tar or installation from the target component 330tar onward.

Moreover, when the link display 332 corresponding to the individual component 330 is selected by the worker 84 in the disassembled perspective view 308, the work guide screen 400 (work guide display) of the selected individual component 330 is displayed (FIGS. 3, 9, and 10). When the target component 330tar has been selected as the individual component 330 selected by the worker 84, the worker 84 can easily reach the work guide screen 400 of the target component 330tar. Furthermore, when the link display 332 corresponding to the individual component 330 related to installation or removal of the target component 330tar (the related component 330ass) is selected by the worker 84, the worker 84 can select and view solely the work guide screen 400 of the related component 330ass that the worker 84 is interested in. It therefore becomes possible for the worker 84 to quickly select and understand required work and important information that should be noted regarding that work.

The above makes it possible to achieve that “entire work is easy to understand”, “a main point of entire work can be easily understood”, and “important information can be easily understood”.

In the present embodiment, the arithmetic operation section 36 (control device) displays, with substantially the same reduction scale in the disassembled perspective view 308, all or some of the plurality of individual components 330 configuring the component unit 202 (FIGS. 6-8). This makes it easy for the worker 84 (user) to imagine actual entire work just by looking at the disassembled perspective view 308.

In the present embodiment, the component (suspension 350) that is installed or removed in a non-disassembled state is displayed in the disassembled perspective view 308 as the individual component 330 unchanged in the non-disassembled state (FIG. 7). As a result, the worker 84 does not need to take into account unrequired disassembly work and so on, and can confirm installation or removal of the individual component 330 in a display state based on an actual work state. Moreover, compared to the case of display in a disassembled state, a required display region becomes smaller and therefore an entire display becomes easier to see in the case of display in the non-disassembled state.

In the present embodiment, the manual data Dm includes the disassembled perspective view data Depv for a plurality of the component units 202 (FIG. 1). In addition, the arithmetic operation section 36 (control device) displays, all together, thumbnails of a plurality of the disassembled perspective views 204 corresponding to the plurality of component units 202 (FIG. 5). Furthermore, when any one of the disassembled perspective views 204 displayed as the thumbnails is selected via the operation input section 34 (operation input device), the arithmetic operation section 36 displays the selected disassembled perspective view 204 in an enlarged form on the monitor 40 together with the work guide link display 332 (FIGS. 3, and 6-8). This makes it possible for the worker 84 (user) to utilize a thumbnail display to visually or intuitively retrieve which component unit 202 includes the individual component 330 that is a target of the work of the worker 84 himself or herself (the target component 330tar).

In the present embodiment, the arithmetic operation section 36 (control device) displays the plurality of individual components 330 in the disassembled perspective view 308 without displaying the names thereof (FIGS. 6-8). Moreover, the arithmetic operation section 36 includes the link mark 342 (symbolized link display 332) in the disassembled perspective view 308, and displays an explanation of the link mark 342 in the symbol explanation field 310 serving as a blank space (FIGS. 6-8). As a result, although there is a limitation on the display region of the monitor 40, lowering of visibility due to a large number of detailed names being displayed is avoided, so that the individual components 330 are each made conspicuous, thereby enabling visibility of the worker 84 (user) to be improved.

In the present embodiment, the individual component 330 in the disassembled perspective view 308 includes the screw 346 (FIG. 6). Moreover, the manual data Dm includes data of the number of screws 346 that are required for each fastening region of the screw 346 (FIG. 6). The arithmetic operation section 36 (control device) displays one screw 346 along with the number of screws 346, for each fastening region of the screw 346, in the disassembled perspective view 308 (FIG. 6).

As a result, in the disassembled perspective view 308, one screw 346 is displayed for each fastening region of the screw 346, hence, although there is a limitation on the display region of the monitor 40, the individual components 330 are each more largely displayed, thereby enabling visibility of the worker 84 (user) to be improved. In addition, since the number of screws 346 is displayed, the worker 84 can recognize the required number of screws 346.

### B. Modified Examples

Note that the present invention is not limited to the above-described embodiment, and that, of course, a variety of configurations may be adopted, based on described content of the present Description. For example, the configurations indicated below may be adopted.

### B-1. Application Target

In the above-described embodiment, the electronic manual display system 10 or electronic manual display method has been applied to the vehicle 80 as the completed product (FIG. 1). However, from a viewpoint of using the disassembled perspective view 308 and the work guide link display 332, for example (FIGS. 6-8), the present invention is not limited to this. For example, the system 10 or electronic manual display method may also be used in any of a plurality of component modules (for example, an engine, a motor, a navigation device) configuring the vehicle 80. Alternatively, the system 10 or electronic manual display method may also be used in a device other than the vehicle 80 (for example, a moving body such as a ship or aircraft, a robot, a manufacturing device, or a household electric appliance).

### B-2. Configuration of Electronic Manual Display System 10

In the above-described embodiment, the terminal 12 has been configured as a dealer terminal belonging to the dealers A, B (FIG. 1). However, from a viewpoint of using the disassembled perspective view 308 and the work guide link display 332, for example (FIGS. 6-8), the present invention is not limited to this. For example, the terminal 12 may be configured as a personal terminal.

In the above-described embodiment, the manual file Fm used in the terminal 12 is downloaded from the server 14 to be stored in the storage section 38 of the terminal 12 (FIG. 1). However, from a viewpoint of using the disassembled perspective view 308 and the work guide link display 332, for example (FIGS. 6-8), the present invention is not limited to this. For example, the manual file Fm may be stored in the storage section 38 via a recording medium (a USB memory, or the like). Alternatively, the manual file Fm used in the terminal 12 may be a so-called ASP (Application Service Provider) type not involving any downloading, and the manual file Fm of the server 14 may be utilized.

### B-3. Electronic Manual 90

### (B-3-1. Electronic Manual 90 Overall)

The electronic manual 90 of the above-described embodiment displays, as screens, the high order category selection screen 100, the thumbnail screen 200, the enlarged display screen 300, the work guide screen 400, and the detailed work screen 500 (FIG. 3). However, if attention is focused on use of the enlarged display screen 300, for example, it is also possible for one or a plurality of the screens other than the enlarged display screen 300 to be omitted.

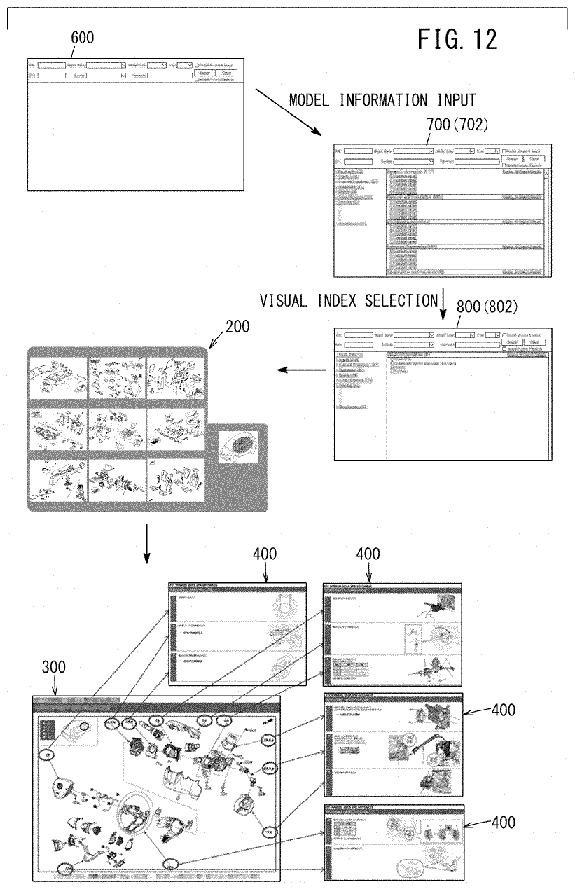

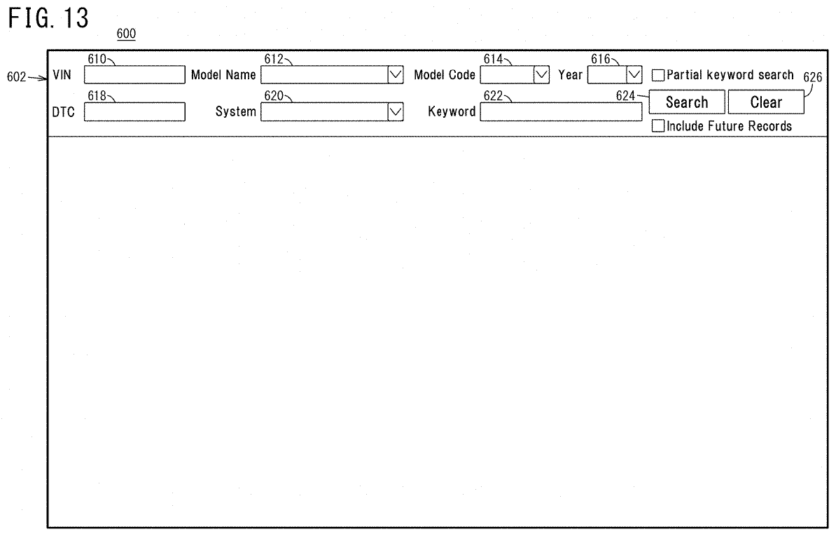

FIG. 12 is a view explaining one example of change of screens in an electronic manual 90 of a modified example. FIGS. 13-15 are views showing first through third examples of the screen in the modified example. The change of screens shown in FIG. 12 is achieved by a flow similar to that of FIG. 2. Specifically, display of an initial screen 600, a search information display screen 700, and an index information display screen 800 that will be described below, is performed as processing included in step S1 of FIG. 2 or processing instead of step S1.

In the modified example shown in FIG. 12, when the electronic manual 90 is opened, the initial screen 600 (FIG. 13) is displayed. The initial screen 600 includes a search conditions input region 602. The search conditions input region 602 includes a vehicle identification number input field 610, a model name input field 612, a model code input field 614, a year input field 616, a diagnostic trouble code input field 618, a system input field 620, a keyword input field 622, a search button 624, and a clear button 626. The model name input field 612, the model code input field 614, the year input field 616, and the system input field 620 are configured to allow pull-down type list selection to be performed.

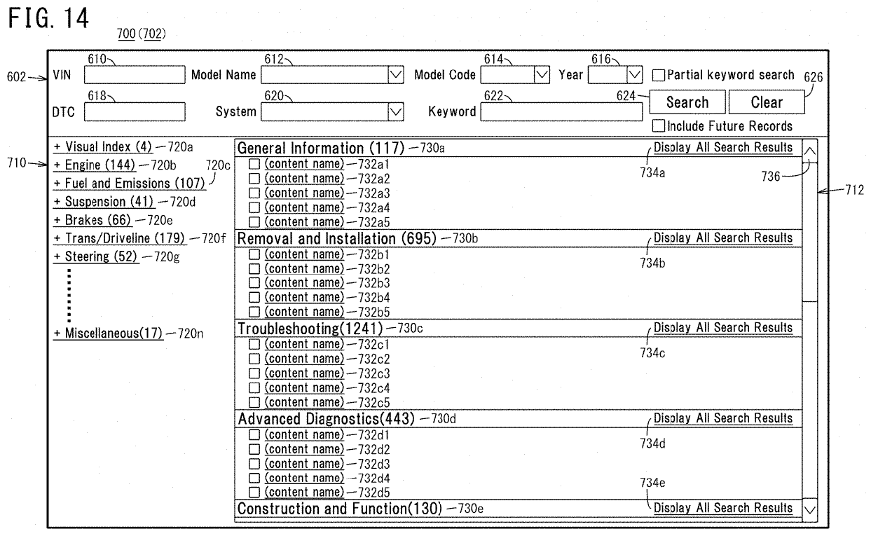

When the search button 624 is pressed in a state where specific information has been input to any one or a plurality of the input fields 610, 612, 614, 616, 618, 620, 622 of the initial screen 600, a screen showing information corresponding to input information (the search information display screen 700) is displayed. For example, when the search button 624 is pressed in a state where a specific model name has been input to the model name input field 612, a model information display screen 702 (FIG. 14) as the search information display screen 700, is displayed.

The model information display screen 702 includes an index display region 710 and a model information display region 712, in addition to the search conditions input region 602 similar to that of the initial screen 600.

The index display region 710 includes a plurality of index selection choices 720a-720n (where n is an integer from 5 to 30, for example) as index selection choices. Of these, the index selection choice 720a is a visual index selection choice. Moreover, the index selection choices 720b-720e are selection choices indicating portions of the vehicle 80. The index selection choice 720n is a selection choice indicating “miscellaneous”.

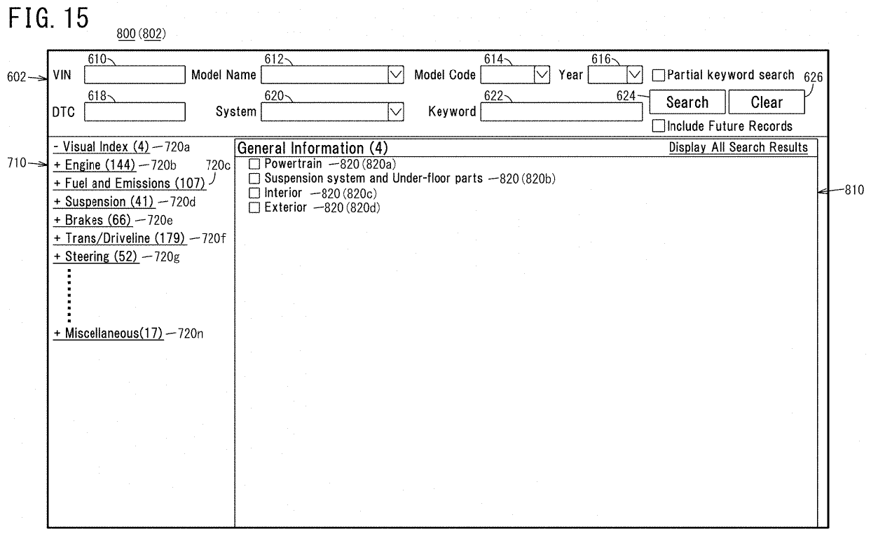

Each of the index selection choices 720a-720n (hereafter, also called “selection choices 720a-720n”) includes link information. When any one of the selection choices 720a-720n is selected, a screen corresponding to the selected selection choice (the index information display screen 800) is displayed. For example, when the visual index selection choice 720a is selected in the index display region 710, a visual index display screen 802 (FIG. 15) as the index information display screen 800, is displayed. The visual index display screen 802 will be mentioned later.

In FIG. 14, a numerical value in parentheses assigned to each of the selection choices 720a-720n indicates the number of low order selection choices corresponding to each of the selection choices 720a-720n. For example, in the index selection choice 720a, “4” is displayed in parentheses, and this 4 indicates the number of later-mentioned high order category selection choices 820a-820d.

The model information display region 712 includes: model information item names 730a-730e; individual content names 732a1-732a5, 732b1-732b5, 732c1-732c5, 732d1-732d5 . . . ; list display requests 734a-734e; and a scroll bar 736. The individual content names 732a1-732a5 . . . include link information, and when any one of the individual content names 732a1-732a5 . . . is selected, a screen (not illustrated) corresponding to the selected content name, is displayed.

As described above, when the visual index selection choice 720a is selected in the index display region 710, the visual index display screen 802 (FIG. 15) is displayed. The visual index display screen 802 includes a high order category selection region 810, in addition to the search conditions input region 602 and the index display region 710 similar to those of the model information display screen 702.

The high order category selection region 810 includes the high order category selection choices 820a-820d. The high order category selection choices 820a-820d of FIG. 15 display, by text, content similar to that of the high order category selection choices 106a-106d of FIG. 4. In other words, the high order category selection choices 820a-820d of FIG. 15 correspond to the high order category selection choices 106a-106d of FIG. 4.

When any one of the high order category selection choices 820a-820d is selected, the thumbnail screen 200 (FIG. 5) is displayed in the same manner as in the above-described embodiment. Hereafter, the high order category selection choices 820a-820d will also be called “selection choices 820a-820d”, and will be collectively referred to as “high order category selection choices 820” or “selection choices 820”. Subsequent change of screens is similar to that in the above-described embodiment. Note that although in FIG. 12, the detailed work screen 500 of FIG. 3 is omitted, it is in fact possible for the detailed work screen 500 similar to that of FIG. 3 to be displayed also in the modified example of FIG. 12.

As can be understood from the above, in the modified example shown in FIGS. 12-15, the manual data Dm includes: classification data Dc relating to the high order category selection choices 820a-820d (classification displays) that indicate a high order classification (a powertrain, and so on) including the plurality of component units 202 (FIG. 5); and hierarchy data Dt relating to a display hierarchy. Moreover, the arithmetic operation section 36 (electronic manual control device) displays the high order category selection choices 820a-820d on a screen (the index information display screen 800) of higher order hierarchy than the disassembled perspective view 308, based on the hierarchy data Dt (FIGS. 12 and 15).

This makes it possible for a hierarchical structure to be partially adopted for display. Hence, it enables labor involved in construction or improvement, version upgrading, or data updating of the system, to be simplified. In addition, the high order category selection choices 820a-820d (classification displays) indicating the high order classification including the plurality of component units 202 are displayed on the screen 800 of higher order hierarchy than the disassembled perspective view 308, thereby making it easy for the user to reach the disassembled perspective view 308 using the selection choices 820a-820d as a guide.

### (B-3-2. Enlarged Display Screen 300)

In the disassembled perspective view 308 of the enlarged display screen 300 of the above-described embodiment, the name of the individual component 330 is not displayed (FIGS. 6-8). However, the names of one or a plurality of the individual components 330 may be displayed in the disassembled perspective view 308. In this case, a configuration may be adopted whereby, although the name of the individual component 330 is not usually displayed, the name of the individual component 330 is displayed when a cursor is moved to the individual component 330 or to a region in a vicinity (a region whose range has been set) of the individual component 330.

In the enlarged display screen 300 of the above-described embodiment, the work guide link display 332 is disposed in a vicinity of the individual component 330 shown by perspective view (FIGS. 6-8). However, from a viewpoint of using the disassembled perspective view 308 and the work guide link display 332, for example (FIGS. 6-8), the present invention is not limited to this. For example, it is also possible for the individual component 330 itself shown by perspective view to be used as the work guide link display 332. That is, a configuration may be adopted whereby when the worker 84 selects the individual component 330 via the operation input section 34, the work guide screen 400 is displayed.

In the enlarged display screen 300 of the above-described embodiment, the individual components 330 are each displayed with substantially the same reduction scale (FIGS. 6-8). However, from a viewpoint of using the disassembled perspective view 308 and the work guide link display 332, for example (FIGS. 6-8), the present invention is not limited to this. For example, some of the individual components 330 may be displayed with a reduction scale greatly different from that of another individual component 330.

The disassembled perspective view 308 of the above-described embodiment includes the work guide link display 332 and the screw work display 334, in addition to the perspective view of each of the individual components 330 (FIGS. 6-8). However, from a viewpoint of using the work guide link display 332, for example (FIGS. 6-8), it is also possible to omit the screw work display 334. Alternatively, it is also possible to omit any of the target torque, the required number, and a need-for-replacement at the time of disassembly in the screw work display 334.

### (B-3-3. Work Guide Screen 400)

In the above-described embodiment, when any one of the work guide link displays 332 is selected in the enlarged display screen 300, the enlarged display screen 300 is switched to the work guide screen 400 (FIG. 3). However, from a viewpoint of performing work guide display of the individual component 330 when the link display 332 is selected, for example, the present invention is not limited to this. For example, the work guide screen 400 may be displayed superimposed on the enlarged display screen 300.

### (B-3-4. Other)

In the above-described embodiment, work of the target component 330tar or the related component 330ass can be guided by a method shown in FIG. 3. However, it is also possible for another method for guiding work of the target component 330tar or the related component 330ass to be used in combination. A possible such method is, for example, using keyword search to call up the work guide screen 400 or the detailed work screen 500 by a keyword relating to the component unit 202 or the individual component 330. Alternatively, a search method may be used in which a list of work is displayed for each component unit 202, and work corresponding to the work guide screen 400 or the detailed work screen 500 is selected from that list.

### REFERENCE SIGNS LIST

10: electronic manual display system
12: dealer terminal
34: operation input section (operation input device)
36: arithmetic operation section (control device, electronic manual control device)
38: storage section (storage device)
40: monitor
80: vehicle (completed product)
84: worker (user)
200: thumbnail screen
202: component unit
204: disassembled perspective view displayed as thumbnail
308: enlarged disassembled perspective view
310: symbol explanation field (explanation of link display)
330: individual component
331: auxiliary line
332: work guide link display (link display)
342: link mark (symbolized link display)
346: screw
350: suspension (component installed or removed in a non-disassembled state)
400, 400a, 400b: work guide screen (work guide display)
800: index information display screen (screen of higher order hierarchy)
820a-820d: classification display
Depv: disassembled perspective view data
Dog: work guide data
Dogl: work guide link data
Dm: manual data
Dscw: screw work data (data of number of screws)

1. An electronic manual display method by which a control device acquires, from a storage device, manual data explaining work of a plurality of individual components configuring a completed product or a component module for the completed product, and displays the manual data on a monitor,
wherein the manual data at least includes:
disassembled perspective view data relating to a disassembled perspective view of an entire component unit that includes some of the plurality of individual components and configures the completed product or the component module;
work guide data relating to a work guide display explaining work of the individual component; and
work guide link data relating to a link display associating each of the individual components in the disassembled perspective view with the work guide display,
wherein the disassembled perspective view of the entire component unit displays the plurality of individual components in a disassembled state where the plurality of individual components are aligned in a same visual field direction, along with a common auxiliary line indicating linkage of mutual installation relationships of the plurality of individual components, and
wherein the control device
displays the link display correspondingly to an arrangement of the individual component, in the disassembled perspective view of the entire component unit, and
when any one of the link displays is selected via an operation input device configured to receive operation input from a user, displays the work guide display of the individual component corresponding to the selected link display on the monitor.

2. The electronic manual display method according to claim 1, wherein
the control device displays, with substantially a same reduction scale in the disassembled perspective view, all or some of the plurality of individual components configuring the component unit.

3. The electronic manual display method according to claim 1, wherein
a component that is installed or removed in a non-disassembled state is displayed in the disassembled perspective view as the individual component unchanged in the non-disassembled state.

4. The electronic manual display method according to claim 1, wherein
the manual data includes the disassembled perspective view data for a plurality of the component units, and
the control device
displays, all together, thumbnails of a plurality of the disassembled perspective views corresponding to the plurality of component units, and
when any one of the disassembled perspective views displayed as the thumbnails is selected via the operation input device, displays the selected disassembled perspective view in an enlarged form on the monitor together with the link display.

5. The electronic manual display method according to claim 1, wherein
the control device
displays the plurality of individual components in the disassembled perspective view without displaying names thereof, and
includes, in the disassembled perspective view, the link display that has been symbolized, and displays an explanation of the symbolized link display in a blank space.

6. The electronic manual display method according to claim 1, wherein
the individual components in the disassembled perspective view each include a screw,
the manual data includes data of a number of screws that are required for each fastening region of the screw, and
the control device displays one screw along with the number of screws, for each fastening region of the screw, in the disassembled perspective view.

7. An electronic manual control device that acquires, from a database, manual data required in work of a plurality of individual components configuring a completed product or a component module for the completed product, and displays the manual data on a monitor,
wherein the manual data at least includes:
disassembled perspective view data relating to a disassembled perspective view of an entire component unit that includes some of the plurality of individual components and configures the completed product or the component module;
work guide data relating to a work guide display explaining work of the individual component; and
work guide link data relating to a link display associating each of the individual components in the disassembled perspective view with the work guide display,
wherein the disassembled perspective view of the entire component unit displays the plurality of individual components in a disassembled state where the plurality of individual components are aligned in a same visual field direction, along with a common auxiliary line indicating linkage of mutual installation relationships of the plurality of individual components, and
wherein the electronic manual control device
displays the link display correspondingly to an arrangement of the individual component, in the disassembled perspective view of the entire component unit, and
when any one of the link displays is selected via an operation input device configured to receive operation input from a user, displays the work guide display of the individual component corresponding to the selected link display on the monitor.

8. The electronic manual control device according to claim 7, wherein
the manual data includes:
classification data relating to a classification display indicating a high order classification including a plurality of the component units; and
hierarchy data relating to a display hierarchy, and
the electronic manual control device displays the classification display on a screen of higher order hierarchy than the disassembled perspective view, based on the hierarchy data.
